(19) United States
(12) Patent Application Publication
(10) Pub. No.: US 2016/0225109 A1
(43) Pub. Date: Aug. 4, 2016

(54) RESTAURANT METHOD

(71) Applicant: Bernard R. Wilson, Mississauga (CA)

(72) Inventor: Bernard R. Wilson, Mississauga (CA)

(21) Appl. No.: 15/094,346

(22) Filed: Apr. 8, 2016

Related U.S. Application Data
(63) Continuation of application No. 14/480,181, filed on Sep. 8, 2014, now abandoned.
Application No. 14/480,181 is a continuation of application No. 14/164,600, filed on Jan. 27, 2014, now abandoned.
Application No. 14/164,600 is a continuation of application No. 12/979,150, filed on Dec. 27, 2010, now abandoned.
(60) Provisional application No. 61/389,308, filed on Oct. 4, 2010.

(51) Int. Cl. G06Q 50/12; G06Q 30/06

(52) U.S. Cl. CPC G06Q 50/12; G06Q 30/0609

(57) ABSTRACT

A method for selling restaurant food. One method, for selling food, comprises the steps of: providing a buffet restaurant; selling containers to customers of the buffet restaurant; and permitting purchasers of said containers to place therein food from the buffet for take-away purposes. Another method is for use with a buffet restaurant of the all-you-can-eat type, wherein a patron is, in exchange for payment of a fixed price, allowed to eat as much as he or she wishes from the buffet in a single sitting. This method comprises the step of: allowing said patron, for an additional price, the opportunity to retrieve a predetermined quantity of food from the buffet for take-away purposes. The additional price can be embodied in the sale of a container to the patron, the volume of the container defining the predetermined quantity.

### CROSS-REFERENCE

This application is a continuation patent application of U.S. patent application Ser. No. 14/480,181 filed Sep. 8, 2014 which is a continuation application of U.S. patent application Ser. No. 14/164,600 filed Jan. 27, 2014 which is a continuation application of U.S. patent application Ser. No. 12/979,150 filed Dec. 27, 2010 entitled RESTAURANT METHOD which claims priority to U.S. Provisional Patent Application Ser. No. 61/389,308, filed Oct. 4, 2010, incorporated in its entirety herein by reference.

### BACKGROUND OF THE INVENTION

1. Field of the Invention

The present invention relates to a unique method for selling restaurant food.

2. Prior Art.

As a restaurant dining option, restaurant buffets are popular among many customers. Frequently, such buffets are “all you can eat”, which can lead to excessive food consumption as well as food waste.

Many restaurants, including those with buffets, sell their food in take-away containers, for pick-up or delivery and occasionally even to eat-in. Further, it is known in a la carte restaurants to place leftovers in take-away containers [“doggy bags”] so that customers can take the leftovers with them after a meal. In each of these scenarios, the container represents an expense for the restaurant owner.

### SUMMARY OF THE INVENTION

Forming one aspect of the invention is a unique method for selling restaurant food, the method comprising the steps of: providing a buffet restaurant; selling containers to customers of the buffet restaurant, i.e. to a person who has already paid for a buffet dinner; and permitting purchasers of said containers to place therein food from the buffet for take-away purposes.

According to another aspect of the invention, containers can be offered for sale to persons other than customers of the buffet restaurant at a price different from that offered to customers of the buffet restaurant.

According to another aspect of the invention, each customer of the buffet restaurant can purchase only one of said containers.

According to another aspect of the invention, each customer of the buffet can purchase one or more of said containers.

According to another aspect of the invention, each customer of the buffet can purchase, at a first price, one of said containers, and at a price different than the first price, one or more other of said containers.

According to another aspect of the invention, said containers can be offered for sale in differing sizes, each size having an associated price.

According to another aspect of the invention, the containers can be sealable so as to prevent leakage,

According to another aspect of the invention, the containers can be insulated.

According to another aspect of the invention, the containers can each incorporate partitions dividing the container into a plurality of compartments.

According to another aspect of the invention, the partitions can be removable.

Forming another aspect of the invention is a method for use with a buffet restaurant, of the all-you-can-eat type, wherein a patron is, in exchange for payment of a fixed price, allowed to eat as much as he or she wishes from the buffet in a single sitting, the method comprising the step of: allowing said patron, for an additional price, the opportunity to retrieve a predetermined quantity of food from the buffet for take-away purposes.

According to another aspect of the invention, the additional price can be embodied in the sale of a container to the patron, the volume of the container defining the predetermined quantity.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

The embodiments of the present invention will now be described by reference to the following figures, in which identical reference numerals in different figures indicate identical elements and in which:

FIG. 1 shows an embodiment of a container in an open position, which container may be used to achieve some aspects of the invention described herein; and

FIG. 2 shows an embodiment of a container in a closed position, which container may be used to achieve some aspects of the invention described herein.

### DETAILED DESCRIPTION OF THE INVENTION

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

The present invention will now be described for the purposes of illustration only in connection with exemplary embodiments.

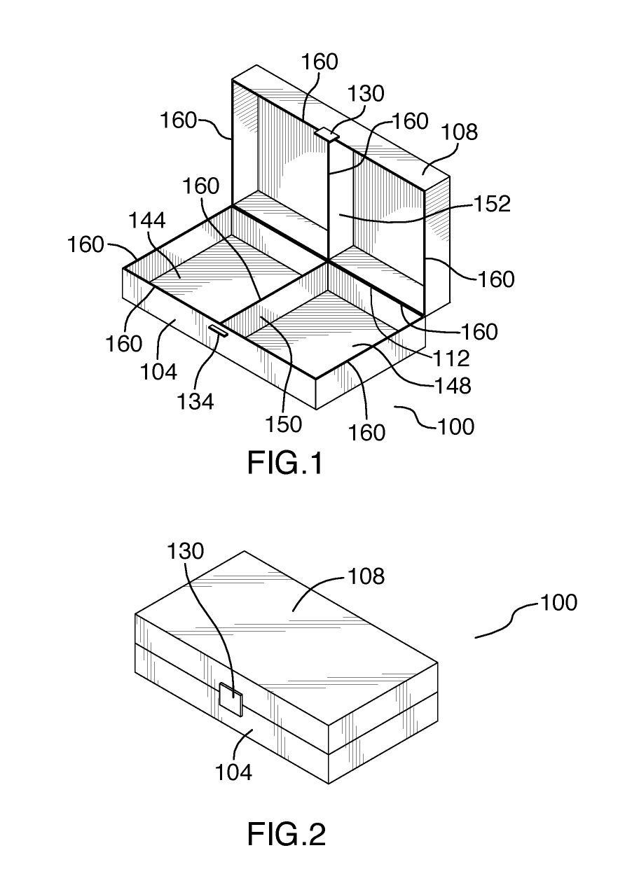

Referring to FIG. 1, there is shown in perspective view a container 100 in an open position which forms an exemplary embodiment of the invention.

The container 100 has a bottom portion 104 and a top portion 108. The top portion 108 is pivotably attached to the bottom portion 104 along a back edge 112 of the bottom portion 104. The top portion 108 of the container 100 is pivotable about the back edge 112 from an open position shown in FIG. 1 to a closed position shown in FIG. 2. Further, the top portion 108 may pivot to a position where the top portion 108 lies in the same plane as the bottom portion 104 (this position not shown).

The container 100 preferably incorporates a means for releasably securing the top portion 108 to the bottom portion 104 in the closed position. The means for releasably securing may be any fastener, including a latch, a clasp or a pin. In the embodiment shown, the means for securing the top portion 108 in the closed position is a latch and flange system. A latch 130 is orientated on the top portion 108 and is formed from a malleable material to permit slight bending. A flange 134 is orientated on the bottom portion 104 and is positioned so as to line up with the latch 130 when the top portion 108 is in the closed position. The latch 130 has a notch (not shown) that engages the flange 134 as the top portion 108 approaches the closed position and, when extra downward force is applied to the top portion 108, the notch slips over the flange 134 and 25 reasonably secures the top portion 108 in the closed position. The top portion 108 may be returned to the open position by disengaging the notch from the flange 134 and pulling the top portion 108 upward.

The container 100 is preferably constructed from a material that limits or prevents the conductivity of heat, such as plastic. The material from which the container is constructed is also durable so as to withstand pressure applied to its outer surface. Alternatively, or additionally, the container 100 may be lined with an insulating material that prevents or diminishes the movement of heat from or into the container 100.

The container 100 may incorporate multiple compartments. The embodiment shown in FIG. 1 incorporates two compartments 144 and 148 but it will be understood by a person skilled in the art that the container may incorporate two or more compartments. A bottom partition 150 and a top portion 152 separate the compartments 144 and 148. When the top portion 108 is in a closed position, the top partition 152 meets the bottom partition 150 so as to separate compartments 144 and 148. In an exemplary embodiment, the partitions 150 and 152 are removable so as to permit the customer to vary the size and number of the compartments.

In an exemplary embodiment, the container 100 incorporates seals 160 to prevent leakage from the container 100 and between compartments 144 and 148 of the container 100 when the top portion 108 is in the closed position. The seals 160 also limit the escape of odour from the container 100 and between compartments 144 and 148 of the container 100 when the top portion 108 is in the closed position. The seals 160 are orientated at a top edge around the perimeter of the bottom portion 104, at the top edge of the bottom partition 150, at a bottom edge around the perimeter of the top portion 108 and at the bottom edge of the top partition 152.

Containers according to the above exemplary embodiment can be used in a unique method for selling restaurant food which forms another aspect of the invention, although it will be understood that the method may be achieved by utilizing any container that may receive food.

The method comprises the steps of: providing a buffet restaurant; selling containers to customers of the buffet restaurant; and permitting purchasers of said containers to place therein food from the buffet. For greater certainty, “customer” shall be understood to mean a person who has already paid for a buffet meal.

This method provides the opportunity for increasing the volume of food sold, which has advantageous impacts on food freshness, taste and preparation efficiency.

As well, the method poses the potential for a ‘free’ revenue stream, in the sense that some customers who, either by accident or compulsiveness, have overfilled their plates may, having already taken the food, purchase a container to take it away out of guilt, rather than allowing it to go to waste.

The method may also result in reduced on-site food consumption as some consumers, freed from the need to ‘get their money worth’, might be satisfied with purchasing a take-away container for the favourite foods that they would otherwise have felt compelled to eat.

Further, this method provides the opportunity for a restaurant buffet to change the overall food cost margin, by modifying the food selection behaviour of customers. This opportunity can be exploited in several ways. First, after a busy mealtime, a restaurant that continuously replenishes its buffet will inevitably have leftovers of one or more types of food. A restaurant could modify food costs by managing remainders such that purchasers of containers take lesser amount of relatively high cost foods and higher amounts of relatively low cost food, solely as a result of the relative amounts of buffet remainders.

Further, by providing containers with partitions, customers can relatively easily mix foods of different types, such as desserts with meats, without co-mingling, which could result in a greater propensity for customers, on a take-away basis, to purchase relatively low-cost foods such as cakes or sweets.

According to another option, containers could conceivably be offered for sale to persons other than customers of the buffet restaurant, typically at a price different from that offered to customers of the buffet restaurant. This could, again, result in a new revenue stream and increase food turnover. The price would typically be different so as to account for the fact that other customers had already paid the price of a buffet meal.

Various other price discrimination and similar rules can be implemented to maximize profits and consumer appeal. For example, some restaurants may permit each customer of the buffet restaurant to purchase only one of said containers. Other restaurants might permit unlimited container purchases.

Others might set prices for first and subsequent containers differently, or provide containers in differing sizes, each having an associated price, or sell containers to senior citizens at prices lower than those sold to others.

The pricing and container availability methodology selected by the restaurant in each case will vary depending upon the target consumer and the specific goal(s) sought to be achieved by the restaurant operator.

Further, whereas the previous description contemplates the sale of a container, persons of ordinary skill will understand that ‘sale’ of a container for the purpose of the method could, for example, involve the sale of a right to retrieve food from a buffet in a container for purposes of take-away, even if the container was given freely to the rights holder, or if the rights holder used a container which he or she already owned.

Thus, the method could also be described as a method for use with a buffet restaurant, of the all-you-can-eat type, wherein a patron is, in exchange for payment of a fixed price, allowed to eat as much as he or she wishes from the buffet in a single sitting, the method comprising the step of: allowing said patron, for an additional price, the opportunity to retrieve a predetermined quantity of food from the buffet for the purpose of take-away. In the method so described, the additional price could be, for example and without limitation, embodied in the sale of a container to the patron, the volume of the container defining the predetermined quantity.

Yet further modifications and variations may be made. Accordingly, the invention should be understood as limited only by the accompanying claims, purposively construed.

Whereas, the present invention has been described in relation to the drawings attached hereto, it should be understood that other and further modifications, apart from those shown or suggested herein, may be made within the spirit and scope of this invention.

What is claimed is:

1. A method comprising the steps of:
providing a buffet restaurant having bowls and plates, the buffet restaurant being of the type that has buffet customers, said buffet customers being defined as persons that have paid or are bound to pay the charge of the buffet restaurant for partaking of the buffet in premises;
selling containers to container customers, container customers being defined as customers that have paid or are bound to pay the charge of the restaurant for the container;
restraining access to the buffet otherwise than to said buffet customers and said container customers;
restraining the retrieval of food in quantity from the buffet otherwise than via one of the plates, bowls and containers; and
restraining removal of the bowls and plates from the restaurant by the buffet customers and the container customers.

2. The method as defined by claim 1 wherein said containers are offered for sale to persons other than buffet customers at a price different from that offered to buffet customers.

3. The method as defined by claim 1 wherein the containers are adapted to be sealed without the use of tools.

4. The method as defined by claim 1 wherein the containers are insulated.
